(19) United States
(12) Patent Application Publication
(10) Pub. No.: US 2007/0226019 A1
(43) Pub. Date: Sep. 27, 2007

(54) Computer implemented method, apparatus, and computer usable program code for configuring language dependent features

(76) Inventors: Michael P. Carlson, Austin, TX (US); Linda A. Lisle, Cedar Park, TX (US); Herman Rodriguez, Austin, TX (US)

Correspondence Address: IBM CORP (YA);C/O YEE & ASSOCIATES PC, P.O. BOX 802333, DALLAS, TX, 75380, US

(21) Appl. No.: 11/385,925

(22) Filed: Mar. 21, 2006

(51) Int. Cl. G06Q 10/00

(52) U.S. Cl. 705/5

(57) ABSTRACT

A computer implemented method, apparatus, and computer usable program code for configuring language dependent features for a hotel room. A hotel guest is associated with a hotel room. The language preference for the hotel guest is located. The language preference is used to configure language dependent features for the hotel room.

### BACKGROUND OF THE INVENTION

1. Field of the Invention

The present invention relates generally to computer networking. Still more particularly, the present invention relates to a computer implemented method, apparatus, and computer usable code for automatically selecting a language preference for a device in a hotel.

2. Description of the Related Art

International travel has resulted in people traveling all around the world for business or pleasure. Hotels and similar guest facilities may accommodate guests from many different countries. Many guests may therefore have a native language different than the local language.

Most electronic devices in hotel rooms, such as televisions and telephones, have graphical-user interfaces that are capable of being set to display the graphical-user interface in a specific language. For example, room and billing information may be presented on a television, and calling information may be presented on a telephone display. Typically, the graphical-user interface defaults to the local language and a user may override the default by specifying a new graphical-user interface language.

To set the graphical-user interface to the guest's native language, either the guest can set the graphical-user interfaces or the hotel staff can set the graphical-user interfaces, and both options have drawbacks. If the guest tries to navigate a local language graphical-user interfaces in order to select the guest's native language graphical-user interfaces, the guest may find the experience frustrating because the guest may be relatively unfamiliar with the local language. If a hotel has to send their staff to manually program all devices in each room for every non-local language speaking guest, the increased labor costs will likely require the hotel to raise room rates.

Moreover, setting the graphical-user interface language manually does not solve other language issues which a guest may face. For example, many television broadcasts carry multiple language soundtracks, so the guest must manually select the appropriate language for each television broadcast. Also, the hotel television may have channels broadcasting in the guest's native language, but they may be placed further down in the channel order, forcing the guest to scroll through numerous channels broadcasting in the local language before being able to find those channels broadcasting in the guest's native language. Thus, incoming communications such as television broadcasts, pay-per-view movies, and video games typically require the guest to manually select or find programming in the guest's native language.

The guest may encounter a similar language-related issue with outgoing communications. When the guest picks up the phone to speak to the hotel staff, if the first staff member who answers the call does not speak the guest's native language, that staff member must track down a second staff member who does speak the guest's native language and transfer the call to the second staff member. Because the call is typically not initially routed to a person who can speak the guest's native language, the staff's time is wasted while one staff member tracks down another. The hotel guest may also get frustrated waiting for hotel staff to track down a staff member who speaks the guest's native language.

In summary, if a hotel guest's native language is different than the local language, the guest may have a frustrating experience staying at the hotel and the hotel may incur increased labor costs trying to accommodate the guest's language preference.

### SUMMARY OF THE INVENTION

Aspects of the present invention provide a computer implemented method, apparatus, and computer usable program code for configuring language dependent features for a hotel room. A hotel guest is associated with a hotel room. The language preference for the hotel guest is located. The language preference is used to configure language dependent features for the hotel room.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a hotel system in which aspects of the present invention may be implemented;

FIG. 2 depicts a block diagram of a data processing system in which aspects of the present invention may be implemented;

FIG. 3 depicts a block diagram of a hotel in which aspects of the present invention may be implemented;

FIG. 4 depicts a block diagram of a room in which aspects of the present invention may be implemented;

FIG. 5 depicts a block diagram of a television in which aspects of the present invention may be implemented;

FIG. 6 depicts a block diagram of a telecommunications device in which aspects of the present invention may be implemented;

FIG. 7 depicts a block diagram of a device interaction in which aspects of the present invention may be implemented;

FIG. 8 depicts a flowchart of a process for setting a language for a device is depicted in accordance with an illustrative embodiment of the present invention; and

FIG. 9 depicts a flowchart of a process for routing outgoing communications is depicted in accordance with an illustrative embodiment of the present invention.

### DETAILED DESCRIPTION OF THE PREFERRED EMBODIMENT

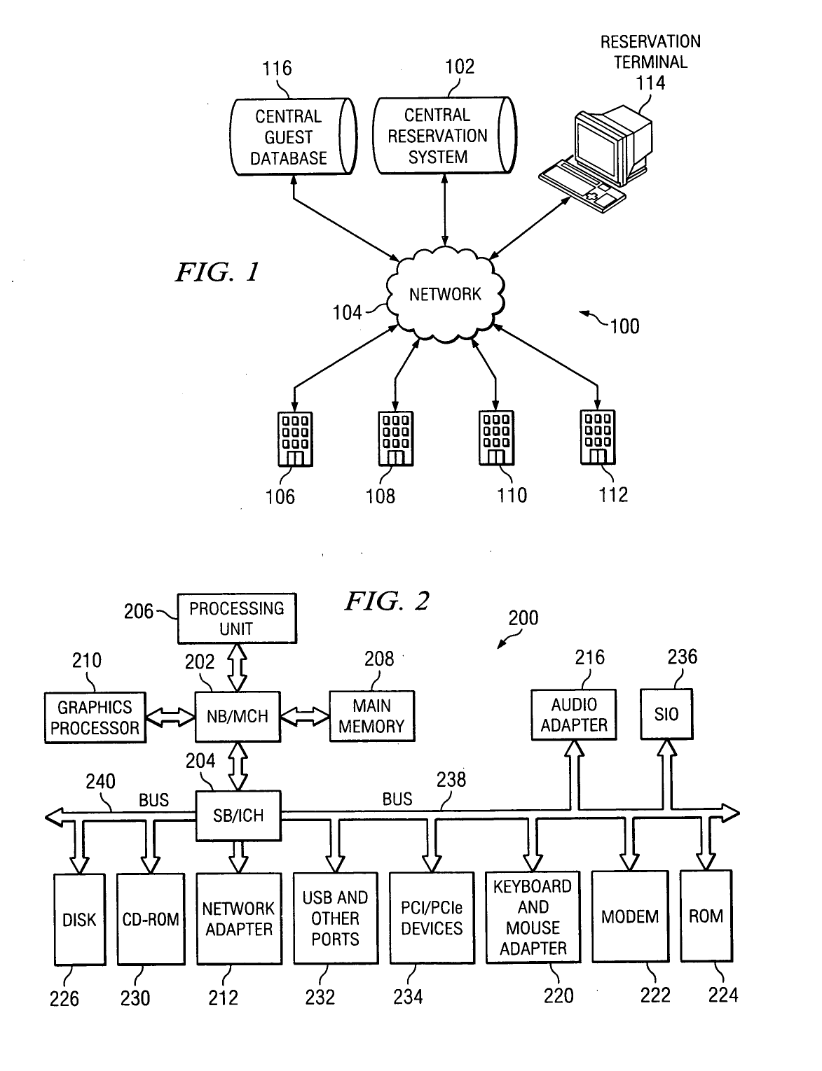

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures and in particular with reference to FIG. 1, a block diagram of a hotel system is shown in which aspects of the present invention may be implemented. In hotel system 100, central reservation system 102 is a central database connected via network 104 to hotel 106, hotel 108, hotel 110, hotel 112, reservation terminal 114, and central guest database 116. Network 104 may be implemented using many different types of networks. For example, a wide area network or even the Internet may be used for network 104. While four hotels are shown here, other numbers of hotel may be used depending on the implementation. In many cases, hundreds or even thousands of hotels may be connected to central reservation system 102 via network 104.

In these examples, central reservation system 102 contains information on the hotels. This information includes, for example, room availability, room availability dates, maximum occupancy for rooms, and pricing information for room rentals. Central reservation system 102 may be comprised of one or more servers.

Reservation terminal 114 is used to access central reservation system 102 and create, modify or delete a room reservation. The room reservation contains information about the hotel, such as, for example, the hotel's location, what size bed the room contains, smoking or non-smoking room, the length of the stay, the guest's name, and payment information such as credit card data. Reservation terminal 114 may be located on the business premises of hotel system 100. Alternatively, reservation terminal 114 may be a remote terminal, such as a personal computer located in a travel agency or at a customer's home. For example, a travel agent who gathers information from a customer may use reservation terminal 114, or a customer at home use reservation terminal 114. One reservation terminal is shown for illustration purposes, but typically multiple reservation terminals are connected to network 104.

Central guest database 116 contains guest profiles. In these examples, each guest profile contains information about a specific guest, such as, for example, name, address, frequent guest number, credit card number, and language preferences. The language preference may be one or more languages that the guest is conversant in, listed in the order of the guest's fluency or comfort level with that language.

For example, when a guest or their agent makes a reservation, central reservation system 102 checks whether the guest's profile is in central guest database 116. If the guest's profile is in central guest database 116, the guest's profile is retrieved to supply information for the reservation, such as the guest's language preferences. If the guest's profile is not in central guest database 116, a new guest profile is created and populated with the appropriate information about the guest. Thus, when a guest makes a room reservation, the guest's profile is updated with the reservation information.

Aspects of the present invention provide a mechanism such that when a guest is associated with a hotel room, such as when the guest checks in, the guest's language preference is automatically located and used to configure language dependent features for the guest's room. As an illustrative example, the video server, phone switch, and devices in the guest's room receive the guest's language preference and configure themselves. For example, the television plays incoming content from the video server in the guest's preferred language, and the phone switch routes outgoing communications to hotel staff members whose language abilities include the guest's preferred language. In these examples, a trigger event, such as when a guest is associated with a hotel room at check-in, starts the process. In these examples, once the trigger event occurs, the process is automated such that neither the hotel staff nor the guest need take any other action to set the language preferences of the devices in the guest's room.

Network 104 is used to provide communications links between the various computers and devices located in the hotels. In the depicted example, network 104 may be a nationwide or worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as central reservation system 102, reservation terminal 114, and central guest database 116 in FIG. 1, in which computer usable code or instructions implementing the processes for embodiments of the present invention may be located. Data processing system 200 may also be used to implement other servers and devices shown in the other figures.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pseries® computer system, running the Advanced Interactive Executive (AIX®) operating system or LINUX operating system (eServer, pseries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the present invention may be applied to a multiprocessor data processing system.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device.

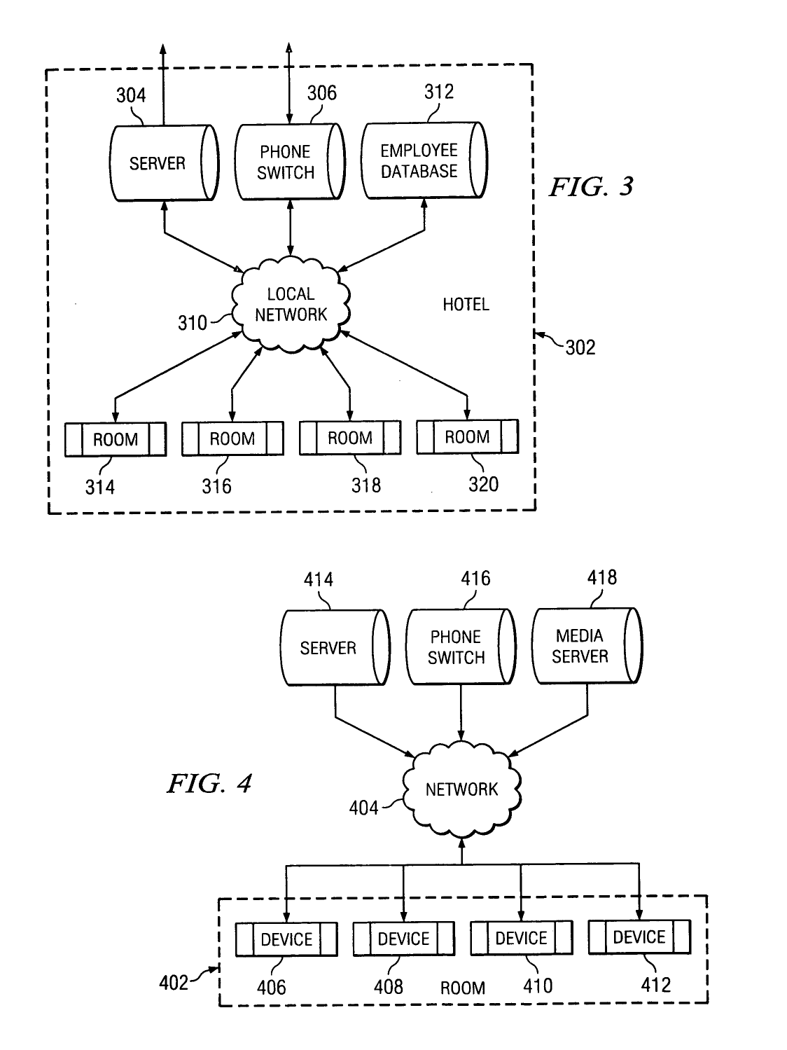

With reference now to FIG. 3, a block diagram of a hotel is shown in which aspects of the present invention may be implemented. Hotel 302 is an example of a hotel, such as hotel 106 shown in FIG. 1.

Server 304 and phone switch 306 are located in hotel 302 and are connected to other components in a hotel system, such as hotel system 100 in FIG. 1, through a network, such as network 104 in FIG. 1. Server 304 and phone switch 306 can be implemented using data processing system in FIG. 2.

Server 304 and phone switch 306 also are connected to local network 310 located within hotel 302. Local network 310 typically connects devices capable of being networked that are located within the hotel. Employee database 312 is connected to local network 310, and contains information about employees working at hotel 302, such as each employee's language abilities, work schedule, and phone extension.

Server 304 may be used to handle data traffic while phone switch 306 may be used to handle telecommunications traffic. Alternatively, phone switch 306 may be software running on server 304. This type of switch is also referred to as a “softswitch.”

The hotel's various rooms, including guest rooms, conference rooms, and hotel staffed rooms, depicted in this example as room 314, room 316, room 318, and room 320, are connected to local network 310. Local network 310 may be comprised of independent computer and telecommunications networks, or a hybrid network with a common packet switching backbone to transport data traffic and voice traffic.

FIG. 3 shows four rooms for illustrative purposes. Of course, the different aspects of the present invention may be applied to other numbers of hotel rooms. Local network 310 may be a wired network, a wireless network, or a combination of wired and wireless technology, including but not limited to Ethernet, Hybrid Fiber Coax (HFC), Fiber Optic, TCP/IP, WiFi (IEEE 802.11), Bluetooth and other networking-related technologies.

With reference now to FIG. 4, a block diagram of a room is shown in which aspects of the present invention may be implemented. In room 402, network 404 may be local network 310 in FIG. 3, or network 404 may be a sub-network of local network 310 in FIG. 3, such as, for example, a network used for all devices in a room or all devices on a floor of the hotel.

Devices 406, 408, 410, and 412, located within room 402, use network 404 to communicate with each other, and with devices external to the room, such as server 414, phone switch 416, and media server 418. Network 404 may also be connected to other components, such as central guest database 116 in FIG. 1.

For example, server 414 can access a central database, such as central guest database 116 in FIG. 1, find a guest's language preference, and then notify network components that provide language dependent features, such as video programming and phone routing, about the guest's language preference. For illustration purposes two embodiments are described.

In an illustrative example, the centralized components that provide language dependent features to one or more hotel rooms are sent the guest's language preference. In this embodiment, server 414 locates the guest's language preference and sends the language preference to network components providing language dependent features, such as phone switch 416 and media server 418, such that each hotel room that is provided language dependent features is automatically provided features in the guest's preferred language. For example, when a guest checks in and is associated with a hotel room, phone switch 416 is sent the guest's language preference and configures itself to route all calls from that guest's room to a hotel staff member that speaks the guest's language. Similarly, once media server 418 receives a guest's language preference, media server 418 configures itself to supply language dependent features, such as movies and television programming, to the guest's room in the guest's preferred language.

For example, if a guest is French speaking, media server 418 can make available and playback those movie files that have a French language track or French subtitle track. In this embodiment, the intelligence for configuring and providing language dependent services in the guest's language is located in the central devices, such as phone switch 416, and media server 418, while the devices in room 402 are “dumb” devices. This illustrative example offers the advantage of being able to use existing devices with little or no modification.

In an alternative example, the devices in each room are “smart” devices that are sent the guest's language preference, and each device then receives the language preference and configures itself to deliver language dependent features in the guest's preferred language. In such an embodiment, server 414 locates and sends the guest's language preference to the devices in the guest's room, such as devices 406, 408, 410, and 412. When devices 406, 408, 410, and 412 receive the guest's language preference, each device automatically configures itself to (i) deliver language dependent features using the guest's preferred language, and to (ii) notify devices external to room 402 about the guest's language preference. For example, a television that receives the guest's language preference can configure itself to automatically play incoming television programs using the audio or subtitle track in the guest's language. Similarly, when the guest uses a phone in the room to place an outgoing call, the phone can notify the telephone switch about the guest's language preference. In response, the telephone switch can automatically route the phone call to a staff member who speaks the guest's language.

Other examples may provide for the language intelligence to be shared between the centralized network components providing guest services, and the devices in the room. For example, the devices in room 402 may receive the guest's language preference and set each device's graphical user interface to use the guest's language, while the centralized components, such as phone switch 416 and media server 418, may use the guest's language preference when routing calls and providing television programming.

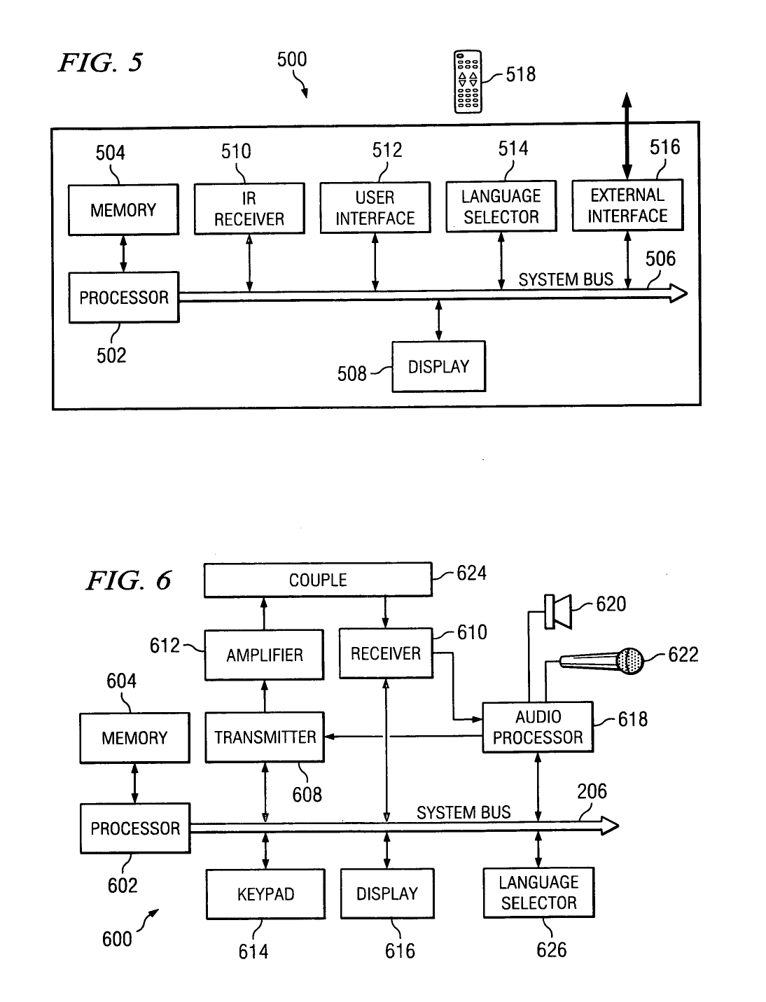

FIGS. 5-6 are provided as exemplary diagrams of devices in a hotel room in which illustrative embodiments of the present invention may be implemented. With reference now to FIG. 5, a block diagram of a television is shown in which aspects of the present invention may be implemented.

Television 500 is used to display content, such as television programs, video games, and billing information. Processor 502 interprets and executes various instructions and commands. Memory 504 stores and retrieves various pieces of information, such as the user's language preference, color and contrast preferences. System bus 506 provides a means for exchanging data between the various components of the television, such as display 508, IR receiver 510, user interface 512, language selector 514, and external interface 516.

Typically, a guest uses remote 518 to send commands to IR receiver 510, which then passes the commands via system bus 506 to processor 502. Processor 502 then interprets the commands and sends messages to other components. For example, when a guest first presses the “power” button on remote 518, processor 502 may send a message via system bus 506 to turn on display 508, and show the content coming into external interface 516.

User interface 512 displays options available to the user on display 508 and allows the user to select the options that the user desires using remote 518. External interface 516 connects television 500 to external networks, such as cable, data, and telecommunications networks. External interface 516 receives incoming content, such as television programs. External interface 516 may also send information to the hotel's billing server, such as credit card information when a user purchases a pay-per-view program.

Language selector 514 allows the guest's language preference to be specified. The guest, using user interface 512, can manually specify language selector 514 to the guest's preferred language. Language selector 514 can also be specified automatically when a guest checks in at the front-desk. For example, the front-desk can send a message indicating the guest's language preference to external interface 516, and processor 502 can then place the guest's language preference in language selector 514.

FIG. 6 is an exemplary block diagram of a telecommunications device in which the present invention may be implemented. Telecommunications device 600 in this example includes a processor 602 for controlling operation of the communication device and a memory 604. The processor 602 may be a general-purpose microprocessor operating under the control of instructions stored a memory, such as memory 604, or device-specific circuitry for controlling the operation of the telephone device. Processor 602 is connected by system bus 606 to transmitter 608, receiver 610, keypad 614, display 616, and audio processor 618. Keypad 614 may be a keypad and/or buttons. Display 616 may be any type of display device including a liquid crystal display (LCD) or other known displays, such as a cathode ray tube or active matrix display.

Transmitter 608 and receiver 610 are coupled to a telephone signal by couple 624 to provide full duplex communication. The telephone signal may be provided by a telephone line (not shown) in a land-based telephone or an antenna, such as for a wireless telephone. Audio processing circuit 618 provides basic analog audio outputs to speaker 620 and accepts analog audio inputs from microphone 622. Received signals are demodulated and decoded by receiver 610. Transmitter 608 encodes and modulates signals passed to it by processor 602 or audio processor 618. The output of the transmitter is amplified by power amplifier 612 to control the power level at which the signal is transmitted.

Processor 602 or audio processor 618 may detect audible call status information and call status codes received by receiver 610. Memory 604 may include a lookup table associating call status information or call status codes with visual call status information, such as text messages. Language selector 626 can be set to the guest's preferred language when the guest checks into the hotel, so that the lookup table containing text messages in the guest's preferred language is used to look up and display messages. Processor 602 detects or receives a call status code and displays an appropriate call status message in the guest's preferred language on display 616. Those of ordinary skill in the art will appreciate that the hardware depicted in FIG. 6 may vary.

Language selector 626 may also used when the guest makes outgoing calls to route calls to someone who speaks the guest's language. For example, when the guest makes an outgoing call using telecommunications device 600, telecommunications device 600 can retrieve the guest's preferred language from language selector 626 and send the language to a phone switch to assist in routing the call to a hotel staff member that speaks the guest's language.

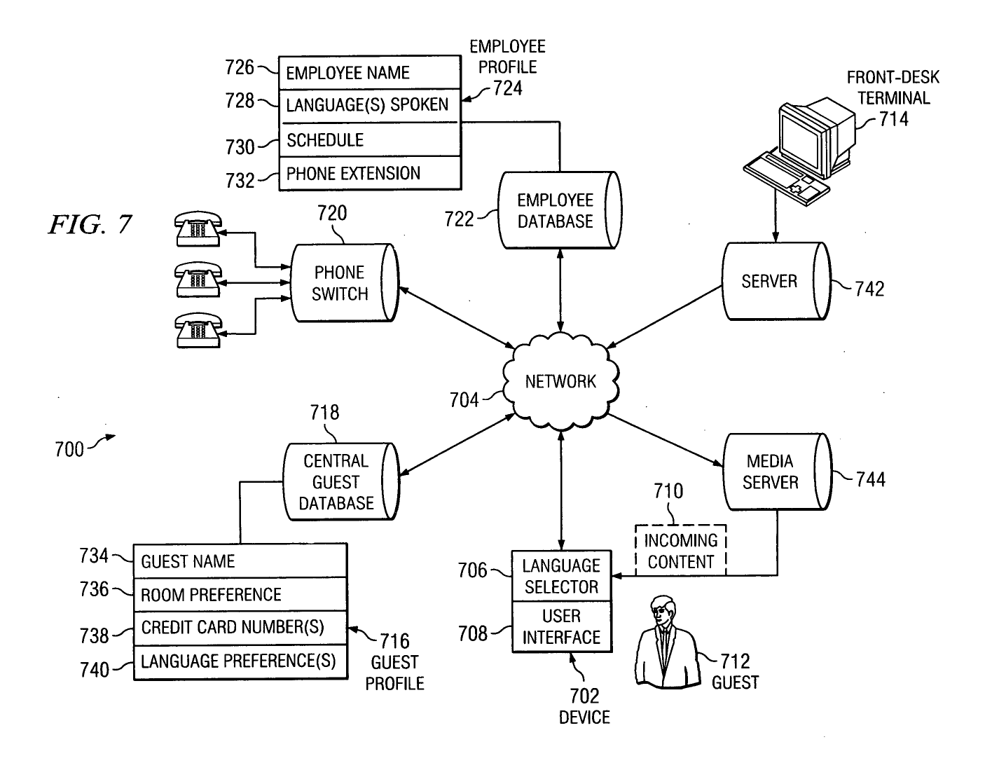

With reference now to FIG. 7, a block diagram of a device interaction is shown in which aspects of the present invention may be implemented. In device interaction 700, device 702 is connected to network 704. Network 704 represents networks external to device 702, such as network 404 in FIG. 4. Device 702 may be a device such as television 500 in FIG. 5, or telecommunications device 600 in FIG. 6.

Different events, such as when a guest makes a room reservation, or when a guest checks into a hotel, can associate a guest with a hotel room. Once the guest is associated with a hotel room, the guest's language preference is located. In this example, when guest 712 checks in, front-desk terminal 714 uses server 742 to retrieve guest profile 716 from central guest database 718, and determine the guest's preferred language. Guest profile 716 contains information about a guest, including guest name 734, room preference 736, credit card number(s) 738, and language preference(s) 740. After retrieving guest profile 716, front-desk terminal 714 uses server 742 to send language preference(s) 740 via network 704 to network components that provide guest services.

In one embodiment, centralized components, such as phone switch 720 and media server 744, receive the language preference and then configure themselves to provide language dependent features to guest 712 using the guest's preferred language. For example, phone switch 720 can route calls from the guest's room to employees who speak guest 712's preferred language, and media server 744 can provide media content to the guest's room in guest 712's preferred language.

In an alternative embodiment, the devices in the room, such as device 702, receive the language preference and configure themselves to provide language dependent features to guest 712 using the guest's preferred language. In this embodiment, device 702 contains an optional language selector 706 that is sent the guest's language when the guest checks into the hotel. Language selector 706 may be a language selector such as language selector 514 in FIG. 5, or language selector 626 in FIG. 6.

In this embodiment each device, such as device 702, configures itself using the guest's language preference and then interacts with the guest in the guest's preferred language. Thus, when guest 712 checks in, front-desk terminal 714 uses server 742 to locate guest profile 716 in central guest database 718, and sends language preference(s) 740 to device 702 via network 704. Then, device 702 configures itself to provide language dependent services in the guest's language, by for example, setting language selector 706 to the guest's preferred language.

Subsequently, when guest 712 finishes checking in at the front-desk and goes into the guest's hotel room, language selector 706 is already set to the guest's preferred language. Therefore, guest 712 can interact with user interface 708 in the guest's preferred language without having to make any language adjustments to the device, and device 702 can play back incoming content 710 in the guest's preferred language. For example, language selector 706 can automatically select the audio or subtitle track that contains the guest's preferred language associated when playing back incoming content 710.

Of course, device 702 can provide many different language dependent features in the guest's preferred language. For example, device 702 can rearrange the channel order so that channels containing an audio or subtitle track in the guest's preferred language are assigned lower numbers than other channels. Thus, when the guest turns on the television, the guest first sees those channels with programming available in guest 712's preferred language.

Similarly, if device 702 is a device used for outgoing communications, such as telecommunications device 600 in FIG. 6, front desk terminal 714 uses server 742 to send language preference(s) 740 to devices in the guest's room, such as device 702. Then, device 702 sets language selector 706 and user interface 708 to guest 712's preferred language. Thus, when guest 712 enters the room and dials a hotel service, such as the front desk, language selector 706 provides guest 712's language preference to devices outside the room, such as phone switch 720, to assist in routing the call to a hotel staff member that speaks guest 712's language preference(s) 740.

For example, phone switch 720 can check employee database 722 to find an employee profile 724 which matches guest 712's language preference. Each employee profile 724 contains employee-related information such as employee name 726, language(s) spoken 728, schedule 730, and phone extension 732. Thus, phone switch 720 can check schedule 730 to find all employees on-duty at that time guest 712 makes the call, and then match the language(s) spoken 728 in employee profile 724 with guest 712's language preference. If language(s) spoken 728 matches guest 712's language preference, phone switch 720 can route the call to that employee's extension.

Typically, phone switch 720 contains a list of employees and their corresponding extensions. In these examples call routing may be expedited by storing each employee's phone number in phone extension 732 in employee profile 724. Thus, if language(s) spoken 728 matches the guest 712's preferred language, the employee's phone extension 732 can be retrieved from employee profile 724 and the call routed without having to look up the employee's phone extension in another table.

If employee database 722 does not contain an employee profile 724 in which language(s) spoken 728 matches guest 712's language preference, a number of different techniques may be used to handle the situation. For example, phone switch 720 might setup a three-way call with guest 712, the front desk, and the hotel's central reservation desk, in which phone switch 720 looks in employee database 722 for an employee at the central reservation desk that matches guest 712's language preference.

For example, if guest 712 calls a hotel service such as the front desk, phone switch 720 can check schedule 730 in employee database 722 to see which employees are scheduled to work the front desk, check those scheduled employee's profiles, and then queue the call to all employees who match guest 712's language preference. Thus, if the first employee called is busy and does not answer, phone switch 720 can automatically route the call to the next employee in the queue matching the guest's language preference.

Language preference(s) 740 may be a set of one or more languages, listed in order of the guest's preference for using the language. Thus, phone switch 720 can route a call to all scheduled employees that match at least one of the languages listed in the guest's language preference(s) 740.

Note that in an alternative embodiment, phone switch 720 first looks up the guest's language preference in guest profile 716 in central guest database 718, instead of having language selector 706 supply the guest 712's language preference, then matches the guest's language preference to the language in employee profile 724 in employee database 722, and then routes the call to the matching employee.

Those of ordinary skill in the art will appreciate that the method described herein also can be used when the guest calls local businesses. For example, if the guest calls a local restaurant to reserve a table or get food delivered, phone switch 720 can access an employee database for the local business and route the call to an employee whose language skills match the guest's preferred language. The hotel might charge a fee to local businesses or to guests for offering such a service.

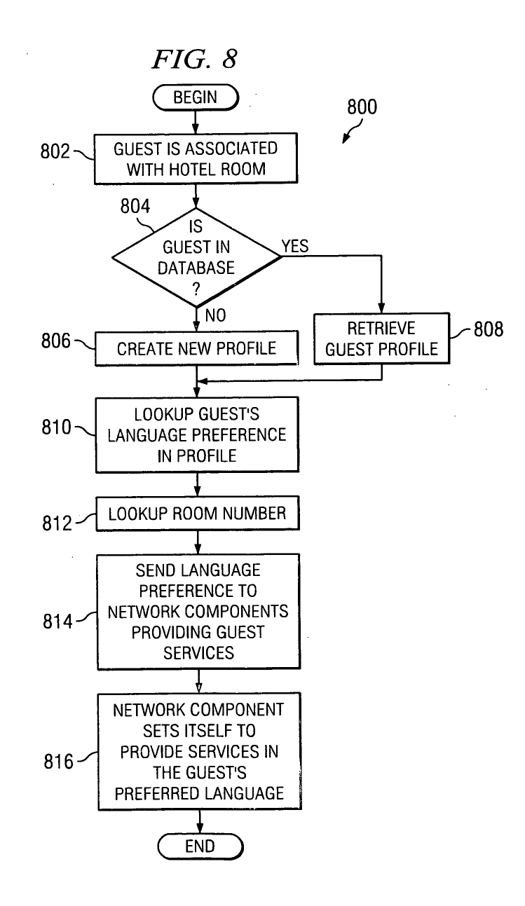

Referring to FIG. 8, a flowchart of a process for setting a language for a device is depicted in accordance with an illustrative embodiment of the present invention. The process illustrated in FIG. 8 may be implemented as a software program running on a server in a hotel, such as server 742 in FIG. 7, and may be used to notify network components that provide guest services, such as media server 744 in FIG. 7 or device 702 in FIG. 7, about a guest's language preference.

The process begins when the software program detects that a guest is associated with a hotel room (step 802), such as when a guest checks in. The software program then tries to locate the guest's language preference. The software program determines whether the guest is in the database (step 804). If the guest is not in the database, the software program creates a new profile for the guest (step 806) in the database. If the software program determines that the guest is in the database, the software program retrieves the guest's profile (step 808).

Next, the software program locates the guest's language preference in the guest's profile (step 810). The software program then finds the room associated with the guest (step 812) and sends the guest's language preference to network components providing language dependent features (step 814) to the guest's room. For example, step 814 can use a network, such as network 704 in FIG. 7, to send the guest's language preference to centralized components such as phone switch 720 and media server 744 in FIG. 7. Alternatively, step 814 can send the guest's language preference to devices in a room, such as devices 406, 408, 410, and 412 in FIG. 4.

When a network component that provides language dependent features receives the guest's language preference, the component configures itself to deliver language dependent features to the guest in the guest's preferred language (step 816), and the process terminates thereafter. For example, step 816 can set a media server to deliver programming in the guest's language for a television in the guest's room, or set a phone switch to route calls from the guest's room to a selected hotel staff member's extension, based on the guest's language preference.

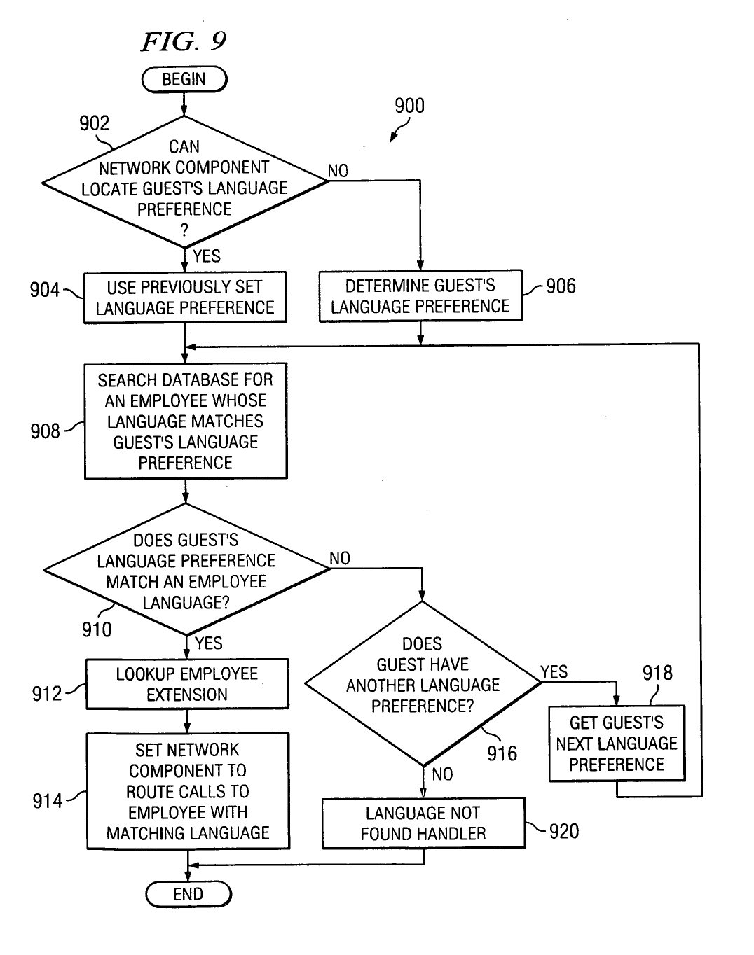

Referring to FIG. 9, a flowchart of a process for routing outgoing communications is depicted in accordance with an illustrative embodiment of the present invention. The process illustrated in FIG. 9 may be implemented in a network component such as phone switch 720 in FIG. 7.

The process begins when a trigger event occurs, such as when a guest is associated with a hotel room, or when the guest interacts with a network component. In this example, the network component may be a device, such as a phone in the guest's room, or a centralized guest services provider, such as a phone switch to which the phone in the guest room is attached. In one embodiment, the phone switch configures itself using the guest's language preference when the guest is associated with the hotel room and then routes calls from that guest's room to hotel staff that speak the guest's preferred language. In an alternative embodiment, the phone configures itself using the guest's language preference when the guest is associated with the hotel room, and then the phone sends the guest's language preference to a second device, such as the phone switch, so that the second device can configure itself to the guest's language preference and, for example, route calls from the guest's room to hotel staff that speak the guest's preferred language.

First, the network component determines whether it can locate the guest's language preference (step 902). If the network component can locate the guest's language preference, then the network component uses the existing language preference (step 904). If the network component cannot locate the guest's language preference, then the network component determines the guest's language preference (step 906). For example, the network component can determine the guest's language preference by querying a device in the room, querying a local guest database in the hotel, or querying a central database, such as central guest database 718 in FIG. 7.

The network component then uses the guest's language preference to search through the employee database for an employee whose language skills match the guest's language preference (step 908). If the guest's language preference matches an employee's language skill (step 910), then the employee's extension is retrieved (step 912), and calls from the guest's room are routed to the employee's extension (step 914), and the process terminates thereafter.

The language preference is a set of one or more languages, listed in the order that the guest prefers to use. If the employee database does not contain an employee whose language matches the guest's first language preference (step 910), then the network component checks whether the guest has another language preference (step 916). If the guest has another language preference, then the routing device retrieves the guest's next language preference (step 918), and searches the employee database for an employee whose language skills match the guest's next language preference (step 908).

If the routing device determines that the guest has no more language preferences (step 916) then a language not found handler is invoked (step 920) and the process terminates thereafter. Language not found handler (step 920) may handle the situation in a variety of ways, such as routing the call to a special staff person such as a manager or supervisor, or creating a three-way call between the hotel staff and an employee at the central reservation system that matches the guest's language preference.

Thus, with the different aspects of the present invention, language dependent features for a hotel room may be automatically configured before guests enter their rooms. When a guest is associated with a hotel, such as when the guest checks in to the hotel, a software process determines the guest's language preferences by locating a guest profile in a central guest database, and sends the guest's language preferences to network components providing language dependent features to each room, such as telecommunications services and media services. The network component may be a centralized service provider such as a media server or phone switch, or the network component may be a device in a room, such as a television or phone. Network components with language dependent features configure themselves to provide features in the guest's preferred language.

Once a network component's language dependent features are configured, each component interacts with the guest using the guest's preferred language. For example, a television device can reorder the order in which channels are displayed so that television programs available in the guest's preferred language are listed first.

Once a network component configures itself to provide language dependent features in the guest's language, the network component may also use the guest's language to configure other network components. For example, when the guest uses a phone device in the guest's room to place an outgoing call, the phone can send the telephone switch the guest's language preference, so that the telephone switch can lookup the guest's language preference, compare the guest's language preference to staff member's language capabilities, and automatically route the phone call directly to a staff member who speaks the guest's language.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for configuring language dependent features in a hotel, the computer implemented method comprising:
responsive to associating a guest with a hotel room in the hotel, locating a language preference for the guest to form an identified language preference; and
configuring language dependent features for the hotel room using the identified language preference.

2. The computer implemented method of claim 1, further comprising:
receiving a request for a feature from the hotel room to form a received request;
identifying the language preference for the hotel room based on the received request; and
providing the feature using the language preference.

3. The computer implemented method of claim 2, wherein the step of identifying the language preference for the hotel room comprises:
identifying the guest associated with the hotel room; and
locating a profile for the guest, wherein the profile includes the language preference.

4. The computer implemented method of claim 2, wherein the receiving step and the identifying step are performed by a server in the hotel.

5. The computer implemented method of claim 1, wherein the language preference comprises a set of languages in an order of preference.

6. The computer implemented method of claim 5, wherein responsive to the language dependent features being unsupported for the first language in the language preference, configuring the language dependent features using a second language in the language preference.

7. The computer implemented method of claim 2, wherein the feature is content for a television, and wherein using the language preference selects at least one of an audio language or a video subtitle.

8. The computer implemented method of claim 2, wherein the feature is a telephone call to a hotel service, and wherein the language preference is used to route the telephone call.

9. An apparatus comprising:
a network;
a network component providing language dependent features to a hotel room in a hotel;
a storage device connected to the network, wherein the storage device contains a language preference; and
a server, wherein the server, responsive to associating a guest with a hotel room in the hotel, locates the language preference for the guest to form an identified language preference, and wherein the network component configures language dependent features for the hotel room using the identified language preference.

10. The apparatus of claim 9, wherein the network component receives a request for a feature from the hotel room to form a received request, identifies the language preference for the hotel room based on the received request, and provides the feature using the language preference.

11. The apparatus of claim 9, wherein the language preference comprises a set of languages in an order of preference.

12. The apparatus of claim 11, wherein responsive to the language dependent features being unsupported for the first language in the language preference, configuring the language dependent features using a second language in the language preference.

13. The apparatus of claim 10, wherein the feature is content for a television, and wherein using the language preference selects at least one of an audio language or a video subtitle.

14. The apparatus of claim 10, wherein the feature is a telephone call to a hotel service, and wherein the language preference is used to route the telephone call.

15. A computer program product comprising:
a computer usable medium including computer usable program code for configuring language dependent features, said computer program product including:
computer usable program code for, responsive to associating a guest with a hotel room in a hotel, locating a language preference for the guest to form an identified language preference; and
computer usable program code for configuring language dependent features for the hotel room using the identified language preference.

16. The computer program product of claim 15, further comprising:
computer usable program code for receiving a request for a feature from the hotel room to form a received request;
computer usable program code for locating a profile for the guest associated with the hotel room, wherein the profile includes the language preference; and
computer usable program code for providing the feature using the language preference.

17. The computer program product of claim 15, wherein the language preference comprises a set of languages in an order of preference.

18. The computer program product of claim 17, wherein responsive to unsupported language dependent features for the first language in the language preference, computer usable program code for configuring the language dependent features using a second language in the language preference.

19. The computer program product of claim 16, wherein the feature is content for a television, and wherein using the language preference selects at least one of an audio language or a video subtitle.

20. The computer program product of claim 16, wherein the feature is a telephone call to a hotel service, and wherein the language preference is used to route the telephone call.
